(19) United States
(12) Patent Application Publication
(10) Pub. No.: US 2024/0283049 A1
(43) Pub. Date: Aug. 22, 2024

(54) LITHIUM CELL WITH LOW THERMAL RESISTANCE TERMINATION

(71) Applicant: Kiwi Technologies Inc., Woburn, MA (US)

(72) Inventors: Adam Bercu, Woburn, MA (US); Jeffrey Sparks, Woburn, MA (US); Daniel Cody, Woburn, MA (US); Daniel Landers, Woburn, MA (US); Max Gieraltowski, Woburn, MA (US)

(21) Appl. No.: 18/444,351

(22) Filed: Feb. 16, 2024

Related U.S. Application Data
(60) Provisional application No. 63/446,512, filed on Feb. 17, 2023.
(60) Provisional application No. 63/446,516, filed on Feb. 17, 2023.

(51) Int. Cl. H01M 10/6551; H01M 10/48; H01M 10/613; H01M 10/615; H01M 10/625; H01M 10/6563; H01M 10/6566; H01M 50/249; H01M 50/503; H01M 50/507; H01M 50/51; H01M 50/522

(52) U.S. Cl. CPC H01M 10/6551; H01M 10/486; H01M 10/613; H01M 10/615; H01M 10/625; H01M 10/6563; H01M 10/6566; H01M 50/249; H01M 50/503; H01M 50/507; H01M 50/51; H01M 50/522

(57) ABSTRACT

In embodiments, a battery system includes battery cell modules. Each battery cell module has a positive lead and a negative lead. The battery system includes a bus bar disposed to be in electrical communication with a positive lead of a first battery cell module and a negative lead of a second battery cell. The bus bar includes heat exchange members in thermal communication with a surrounding working fluid. Each heat exchange member's first dimension is a distance between the positive lead and the negative lead and second dimension is a distance from a bottom of a heat exchange member the plurality of heat exchange members in contact with the positive and negative leads to a top of the heat exchange member. The thermal communication with the working fluid occurs over the length of the first dimension. A ratio of the first dimension to the second dimension is at least 2:5.

### CROSS-REFERENCE TO RELATED APPLICATIONS

This application claims the benefit of priority to a U.S. Provisional No. 63/446,512, filed on Feb. 17, 2023 and U.S. Provisional No. 63/446,516, filed on Feb. 17, 2023; the entire content of each of which is hereby incorporated by reference.

### BACKGROUND

Embodiments of the present disclosure relate to lithium batteries, which are used in various applications, including unmanned aerial vehicles (e.g. drones).

### BRIEF SUMMARY

According to embodiments of the present disclosure, methods of and apparatuses for a battery system are provided.

In some embodiments, a battery system includes a plurality of battery cell modules. Each battery cell module has a positive lead and a negative lead. The battery system further includes a bus bar disposed to be in electrical communication with a positive lead of a first battery cell module of the plurality of battery cell modules and a negative lead of a second battery cell module of the plurality of battery cell modules. The bus bar also includes a plurality of heat exchange members in thermal communication with a surrounding working fluid. Each of the plurality of heat exchange members can have a first dimension and a second dimension. The first dimension is at least a distance between the positive lead and the negative lead. The second dimension is orthogonal to the first dimension and at least a distance from a bottom of the heat exchange member in contact with the positive and negative leads to a top of the heat exchange member. The thermal communication with the working fluid occurs over the length of the first dimension. A ratio of the first dimension to the second dimension is around at least 2:5.

In some embodiments, the heat exchange members have a third dimension orthogonal to the first dimension and second dimension. The third dimension is at least a distance of one or more of the positive lead and the negative lead of the first battery cell module. The ratio of the first dimension to the third dimension is at least 10:1.

In some embodiments, the positive lead and the negative lead are in thermal communication with the bus bar and in electrical communication with the bus bar.

In some embodiments, each battery cell module further includes a plurality of battery cells electrically connected in parallel by a respective positive lead and negative lead of each battery cell of the plurality of battery cells. The respective positive lead and respective negative lead are disposed to thermally conduct heat from each battery cell module to the bus bar, the heat transferred being about at least 90 Watts. In some embodiments, thermal flux is greater than or equal to

$$6 \frac{W}{{cm}^{2}}$$

from cells to bus bar, and with bus bars having different surface area, the heat transferred can change according to this relationship. In some embodiments, thermal resistance of a joint is less than or equal to about 0.166 degrees

$$\frac{° C .}{Watt * {cm}^{2}} ,$$

which total thermal resistance is decreased by multiple units of square centimeters of contact area.

In some embodiments, the bus bar is a first bus bar. The battery system further includes a second bus bar, the second bus bar disposed to be in electrical communication with a positive lead of the second battery cell module of the plurality of battery cell modules and a negative lead of a third battery cell module of the plurality of battery cell modules.

In some embodiments, each of the plurality of battery cell modules are connected in series.

In some embodiments, the plurality of heat exchange members are fins. In some embodiments, fins are an example embodiment of a geometry. In some embodiments, the geometry can be more complex, such as sparse matrix three-dimensional (3D) geometry or complex surfaces that present a high surface area against the fluid, with a Reynolds number that minimizes laminar flow of the fluid.

In some embodiments, the bus bar is made of at least one of aluminum and copper. In some embodiments, the bus bar is made of aluminum with an IACS of greater than 55%. In some embodiments, aluminum is used because it has a three-times higher heat capacity (e.g., the amount of degrees ° C. the thermal mass rises per J of heat), and the much lower bulk density. The lower bulk density allows tuning a much more effective heat sink for thermal transfer to the fluid for the same weight. In some embodiments, a copper bus bar can be if lower resistivity is needed and the additional mass to generate the thermal communication to the working fluid is acceptable.

In some embodiments, the bus bar includes a plurality of vent holes enabling air flow from a bottom of a surface of the bus bar to a top of the surface of the bus bar. In some embodiments, the vent holes maximize airflow through the heat sink in two directions: (1) through the heat sink from air between the cells that cool the lower part of the cells, and (2) the turbulent flow from ejected air from adjacent bus bar vents. The vents therefore maximize the cooling effects in the regions where cooling is needed the most, and is leveraged to normalize the cooling.

In some embodiments, the battery system further includes a temperature sensor.

In some embodiments, the battery system further includes a heating element disposed around the plurality of battery cell modules and configured to warm selected areas of the battery cell modules.

In some embodiments, each of the plurality of heat exchange members is predominantly trapezoidal. In some embodiments, the trapezoidal shape normalizes the current density of the bus bar as the vertical fins begin to overlap with the horizontal mating surface. The trapezoidal shape normalizes around 1.8 A/mm\hat{ }2 current density. In some embodiments, the shape of the heat exchange members can be different based on different specific heat exchange embodiments. In some embodiments, the heat exchange members can include a more complex 3D structure of the fins, a sparse matrix, wirewound, complex surfaces, etc. In some embodiments, if the system were to accept lower current density in certain locations at the expense of additional mass, then the heat exchange members can be rectangular, spherical, more rectangular, or more spherical.

In some embodiments, the bus bar has a thermal conductivity of at least 200 Watt per meter Kelvin.

In some embodiments, the positive lead and the negative lead of the lithium cell have a thermal conductivity of 200 Watt per meter Kelvin.

In some embodiments, the bus bar transfers 100 W of heat to the working fluid. In some embodiments, the bus bar transfers heat with a thermal resistance no greater than

$$\frac{0.03 ° C .}{W} .$$

In some embodiments, a battery system further includes a printed circuit board including a plurality of slots. The positive lead and negative lead of each battery cell are disposed within a respective slot of the plurality of slots. The printed circuit board includes a first plurality of mounting holes. The bus bar includes a second plurality of mounting holes. The first plurality of mounting holes is disposed to align with the second plurality of mounting holes. The bus bar is disposed to be in contact with the positive lead of the first battery cell module of the plurality of battery cell modules and the negative lead of the second battery cell module of the plurality of battery cell modules upon being mounted to the printed circuit board. The positive lead and the negative lead are disposed between the bus bar and the printed circuit board.

In some embodiments, a battery module includes multiple of the battery systems disclosed above. In some embodiments, battery module further includes a bus bar disposed to connect a first battery system of the plurality of battery systems to a second battery system of the plurality of battery systems. =In some embodiments, the bus bar connecting the first battery system and the second battery system is not a heat sink bus bar. The battery module further includes an electronics monitoring module. The battery module further includes one or more wiring harnesses. The battery module further includes one or more contactors.

In some embodiments, a bus bar includes a thermal mass that thermally conducts at least 100 W of heat and electrically with a current density no greater than 1.8 Amps per square millimeter of electricity (e.g., 600 A). In some embodiments, the bus bar conducts

$$6 \frac{w}{{cm}^{2}}$$

at interface and

$$3 \frac{w}{{cm}^{2}}$$

internally. In some embodiments, the thermal mass has a thermal conductivity of

$$200 \frac{w}{m * K} .$$

The thermal mass includes a rectangular base having a plurality of mounting holes and a length, width, and height. In some embodiments, rectangular base has around aspect ratio of 3:2 of the length to the width, the height being around five percent of the width. In some embodiments, the rectangular base is designed to fit battery cells to be connected with enough weight to managed the maximum current density of 1.8 A/mm² based on a material with IACS>55%. The thermal mass further includes a plurality of heat exchange members in thermal communication with a surrounding working fluid. Each of the plurality of heat exchange members have a first dimension and a second dimension. The first dimension is at least a distance between the positive lead and the negative lead. The second dimension is orthogonal to the first dimension and at least a distance from a bottom of the heat exchange member in contact with the positive and negative leads to a top of the heat exchange member. The thermal communication with the working fluid occurs over the length of the first dimension. A ratio of the first dimension to the second dimension is around at least 2:5.

In some embodiments, the heat exchange members have a third dimension orthogonal to the first dimension and second dimension. The third dimension is at least a distance of one or more of the positive lead and the negative lead of the first battery cell module. The ratio of the first dimension to the third dimension is at least 10:1.

In some embodiments, the plurality of heat exchange members are fins. In some embodiments, fins are an example embodiment of a geometry. In some embodiments, the geometry can be more complex, such as sparse matrix three-dimensional (3D) geometry or complex surfaces that present a high surface area against the fluid, with a Reynolds number that minimizes laminar flow of the fluid.

In some embodiments, the plurality of heat exchange members are predominantly trapezoidal. In some embodiments, the trapezoidal shape normalizes the current density of the bus bar as the vertical fins begin to overlap with the horizontal mating surface. The trapezoidal shape normalizes around 1.8 A/mm\hat{ }2 current density. In some embodiments, the shape of the heat exchange members can be different based on different specific heat exchange embodiments. In some embodiments, the heat exchange members can include a more complex 3D structure of the fins, a sparse matrix, wirewound, complex surfaces, etc. In some embodiments, if the system were to accept lower current density in certain locations at the expense of additional mass, then the heat exchange members can be rectangular, spherical, more rectangular, or more spherical.

In some embodiments, the thermal mass includes a plurality of vent holes. The vent holes enabling air flow from a bottom of a surface of the bus bar to a top of the surface of the bus bar. In some embodiments, the vent holes maximize airflow through the heat sink in two directions: (1) through the heat sink from air between the cells that cool the lower part of the cells, and (2) the turbulent flow from ejected air from adjacent bus bar vents. The vents therefore maximize the cooling effects in the regions where cooling is needed the most, and is leveraged to normalize the cooling.

### BRIEF DESCRIPTION OF THE SEVERAL VIEWS OF THE DRAWINGS

FIG. 1 is a diagram illustrating some example embodiments of a battery cooling system.

FIG. 2 is a diagram 20 illustrating some example embodiments of a battery cooling system.

FIG. 3 is a diagram illustrating an example embodiment of a battery cooling system disposed under a drone system.

FIG. 4A is a diagram illustrating an isometric view of a battery cell including a positive lead and negative lead.

FIG. 4B is a diagram illustrating a front view of a battery cell 406 including a positive lead and negative lead.

FIG. 4C is a diagram illustrating a side view of a battery cell.

FIG. 4D is a diagram illustrating a top view of the battery cell.

FIG. 5 is a diagram illustrating some example embodiments of a cell module employed by the present disclosure.

FIGS. 6A-F are diagrams illustrating some example embodiments of a cell sleeve, such as the cell sleeve illustrated by FIG. 5.

FIGS. 7A-C are diagrams illustrating some example embodiments of a printed circuit board (PCB) of the present disclosure.

FIG. 8 is a diagram illustrating some example embodiments of a battery module.

FIGS. 9A-G are diagrams illustrating some example embodiments of a bus bar.

FIG. 10A is a diagram illustrating some example embodiments of a bottom view of the bus bar.

FIG. 10B is a diagram illustrating some example embodiments of a bottom view of a bus bar.

FIG. 11 is a diagram illustrating some example embodiments of an isometric view of a battery module of the present disclosure.

FIG. 12 is a diagram illustrating some example embodiments of a side view of a battery module.

FIG. 13 is a diagram illustrating an example of a battery pack including a first battery module and a second battery module.

FIG. 14 is a diagram illustrating a cross-sectional view of a busbar affixed to a plurality of cells.

FIG. 15 is a diagram illustrating an example embodiment of the busbar disposed against a cell module.

FIG. 16A is a diagram illustrating an embodiment of an unfolded schematic of a battery heater.

FIG. 16B is a diagram illustrating an example embodiment of feature illustrated by FIG. 16A.

FIG. 17 is a diagram illustrating some embodiments of an isometric view of a battery heater.

FIG. 18 is a diagram illustrating some example embodiments of shapes or designs of heat exchange members.

FIGS. 19-21 are cross sectional views of exemplary embodiments of a bus bar and heat exchanger construction, in accordance with an aspect of the present disclosure.

### DETAILED DESCRIPTION

The term “about” means a range of values inclusive of the specified value that a person of ordinary skill in the art would reasonably consider to be comparable to the specified value. In some embodiments, about means within a standard deviation using measurements generally accepted by a person of ordinary skill in the art. In embodiments, about means ranging up to ±10% of the specified value. In some embodiments, about means ranging up to ±5% of the specified value. In some embodiments, about means the specified value.

Lithium batteries are used in various applications because of their high energy density and long cycle life. However, lithium battery cells can experience significant thermal stress, which can occur in usage that is (1) high cycle, (2) low depth of discharge, and (3) high power charge and discharge. Thermal stress can lead to reduced performance and potentially dangerous conditions. Currently, battery cells are thermally managed only at their case surfaces, which limits the ability to dissipate heat efficiently. This can limit the usefulness of lithium-ion cells in applications where high power is required over an extended period of time.

In addition, multiple use cases (e.g., drones, ground robotics) employ batteries that are not optimized for high-power usage scenarios. This leads to reduced efficiency and long charging times. Many types of current batteries require high depth-of-discharge for their use case, which reduces their lifespan and charging efficiency. In some embodiments, the disclosed battery system leverages the battery cell's leads and bus bars (e.g., bus termination material) as a heat transfer medium to cool the battery during high-power usage scenarios. This enables fast charging and high-frequency recharging cycles. In some embodiments, the present disclosure provides for the low depth of discharge use cases which require bidirectional high power and frequent recharging. Therefore, in some embodiments, the disclosed battery system allows for faster charging and extended operating time without the need for swappable batteries. In some embodiments, the battery system disclosed herein is able to maintain a cooler temperature and increase its overall performance, resulting in greater efficiency and productivity for high power spraying drones.

Sustained thermal management of the battery for both heating and cooling in a mass efficient, volume efficient, and energy efficient manner provides specific high power density and continuous high duty cycle operation of a certain class of unmanned electric aircraft in a wide range of ambient conditions. In embodiments, the present disclosure provides a system and method for allowing large amounts of thermal energy to be taken out from and added into an array of battery cells to support not only flight, but high duty cycle flight in a wide range of environmental conditions. The cells can maintain their performance and reliability over an extended period of use by enabling efficient thermal management as disclosed herein.

Currently, heat management of batteries employs phase change materials, liquid thermal management (liquid heating and cooling), evaporative closed system cooling, evaporative cooling (open system), conventional forced air, or vortex tube forced air. Phase change materials allow for absorption (e.g., cooling) of a favorable amount of Joules per Kg per

$$K ( e . g . , \frac{Joules}{Kg * K} )$$

due to high latent heat during phase change. This is favorable for absorbing peak thermal energy. However, it does not sufficiently reject waste heat and significantly reduce the amount of energy entering the closed system. The temperature control typically is limited by the temperature at which the phase change occurs. Examples of phase change materials include liquid nitrogen, evaporative kerosene, and phase change wax.

Liquid thermal management is highly effective at removing waste heat from hot components. However, liquid thermal management is intensely heavy and requires secondary heat exchangers to remove heat from the system. Additionally, liquid thermal management uses additional liquid pumps and liquid-to-air heat exchanger fans. Liquid thermal management comes with a large maintenance burden and can pose safety concerns in a system where coolant can become conductive if contaminated when cooling high voltage components. The temperature control is further typically limited by the ambient temperature.

Evaporative closed system cooling systems and compressor-refrigerant systems are effective at removing heat to temperatures below ambient. However, the equipment used for first compressing the refrigerant is both heavy per joule removed and requires a larger amount of energy in Joules than can be removed from the system. Conventional cooling systems also begin to lose efficiency at higher and lower temperatures.

Open system evaporative cooling systems use evaporating water to absorb heat from another medium. This method of cooling is typically highly energy efficient, however, the size and mass of the system is prohibitively large for a system that is intended to be airborne.

Conventional forced air is light weight and energy efficient in certain applications, particularly when there is a large area heat sink relative to the heat source, such as the heat sinks applied to microprocessors in computers. However, the efficacy of conventional heating is severely limited by the specific geometry of the components intended to be cooled, and that components thermal resistance verses its thermal mass, this application is limited. The temperature controlled is typically limited by the ambient temperature.

Vortex tube forced air methods are typically used to cool the cutting surfaces of machine tools. Vortex tube forced air methods operate similarly to a compressor based cooling system because it uses rapidly expanding air that is effective at absorbing heat as it expands. However, vortex tube forced air methods produce a large amount of waste air, which is energy intensive to generate from the beginning. The methods can also be used for heating in some examples.

Currently, there are no suitable solutions for steady state thermal management that are adequately mass efficient and energy efficient for both addition and removal of thermal energy to or from a system that is intended for airborne use in certain applications. In addition, there is currently no suitable method transferring thermal energy to an interface where it could be removed through conduction in a mass efficient manner to passively eliminate internal thermal gradients. Therefore, it is advantageous to provide a solution that sustains operation for airborne vehicles in certain weight classes at a high duty cycle.

In embodiments of the present disclosure, a system and method are provided herein to provide sustained thermal management of the battery for both heating and cooling in a mass efficient, volume efficient, and energy efficient manner. The system and method allow sustaining specific high power density and continuous high duty cycle operation of a certain class of unmanned electric aircraft in a wide range of ambient conditions. In embodiments, the system and method allow large amounts of thermal energy to be taken out from and added into an array of battery cells to support not only flight, but high duty cycle flight in a wide range of environmental conditions.

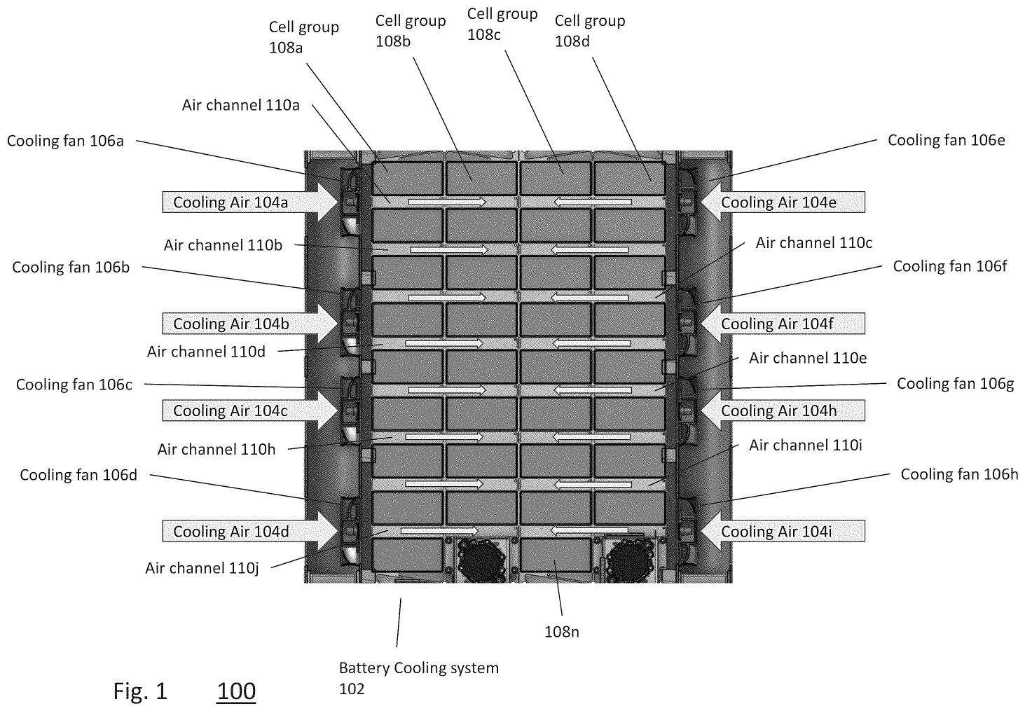

FIG. 1 is a diagram 100 illustrating some example embodiments of a battery cooling system 102. In some embodiments, the battery cooling system is a battery cooling circuit. In some embodiments, the battery cooling system includes a plurality of cell modules 108a-n and a plurality of cooling fans 106a-h. The plurality of cooling fans 106a-h are disposed around respective air channels 110a-j. The plurality of cooling fans 106a-h blow in cooling air 104a-i (e.g., ambient air, a working fluid, etc.) through the respective air channels 110a-j. In some embodiments, two cooling fans (e.g., cooling fan 106a and 106e) blow in cooling air (e.g., 104a and 104e) from opposite sides of the air channel 110a. Blowing in cooling air 104a and 104e from opposite sides creates an fluidic impingement, which aides the working fluid in cooling the batteries of the cell module 108a-n. In some embodiments horizontally (as shown in FIG. 1) aligned fans can produce the same flow/speed/volume of cooling air. Additionally or alternatively, in some embodiments one fan can produce a greater flow/speed/volume of cooling air than the opposing fan such that the point of fluidic impingement can be controlled and designed to occur at a specific battery cell.

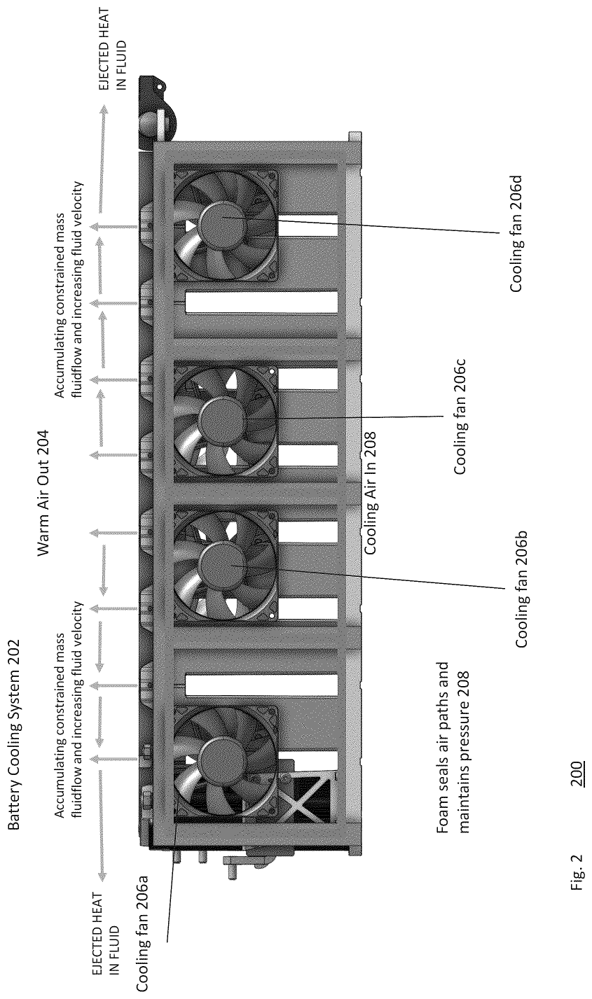

FIG. 2 is a diagram 200 illustrating some example embodiments of a battery cooling system 202. The battery cooling system 202 is disposed with cooling fans 206a-d that intake (e.g. external ambient) cooling air 208 and, after exchanging heat with the elements within the battery cooling system 202, output warm air 204. The warm air out accumulates constrained mass fluid flow and increases fluid velocity before ejecting the heat into the surrounding fluid. In some embodiments, foam 208 is used to seal air paths and maintain pressure within the battery cooling system 202.

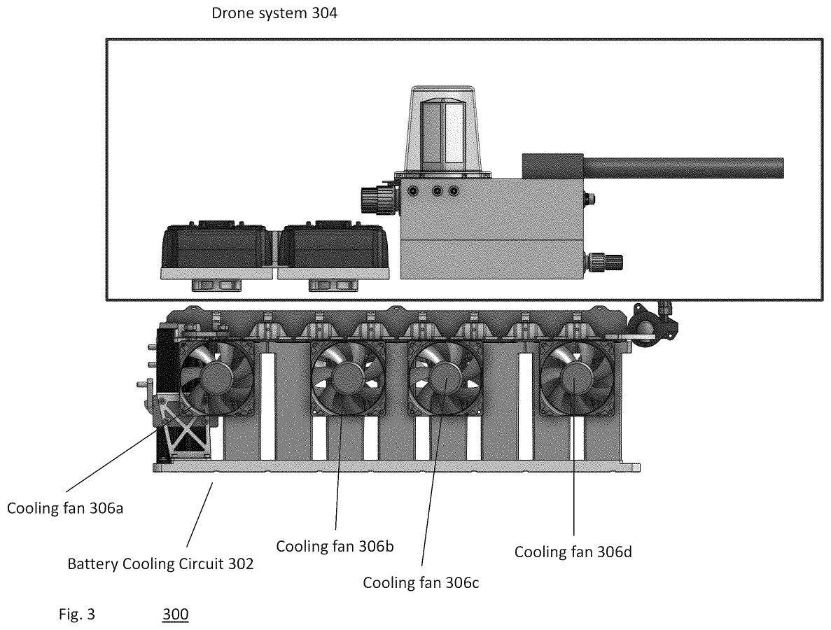

FIG. 3 is a diagram 300 illustrating an example embodiment of a battery cooling system 302 disposed under a drone system 304 (e.g. under, or on a side of a fuselage or nacelle of the drone). The battery cooling system 302, as in FIGS. 1-2, includes a plurality of cooling fans 306a-d. In some embodiments, the heated air that is output from the battery cooling circuit (e.g., warm air 204 of FIG. 2) can cool systems such as air conditioning units or motor controllers that have a higher temperature relative to the warm air 204.

In some embodiments, the present disclosure provides a high power battery design that sacrifices mass and volume energy density in exchange for peak power density, sustained discharge power density, and sustained charge power density. Peak power density is an ability to generate a short term maximum power per kg of at least a peak power threshold (e.g., 5000 W/kg). Sustained discharge power density is a continuous power density of at least a sustained discharge power threshold (e.g., 700 W/kg). Sustained charge power density is a repetitive charge sufficient for high duty cycle operation of at least a sustained charge power density threshold (e.g., 2000 W/kg). A person of ordinary skill in the art can recognize that this threshold can be converted to other units.

In some embodiments, the system provides for the peak power density, sustained power density, and sustained charge power density by reducing generated heat, transferring generated heat, and rejecting generated heat. The system reduces generated heat through battery cell design, array design, and interconnect design. The system transfers generated heat through array design, interconnect design, materials, and intercooler design. The system rejects generated heat through intercooler design, interconnect design, fluid and thermal design.

In some embodiments, thermal transfer system injects ambient air into the intercooled heat exchanging feature, and by doing so, exposes the components to any contaminants and debris that can accumulate or block cooling paths or short across conductive paths if not sufficiently filtered, or discharged. In addition, due to the nature of the heat exchanging features, the effective Discharge Power Energy Density and Specific Charge Power Density in both Watts per Kilogram and Watts per Liter, as well as the Specific Work Factor Density in both Joules per Hour per Kilogram and Joules per Hour per Liter may be reduced below present energy densities. Specific Energy Density in both Watt-Hours per Kilogram and Watt-Hours per Liter will be minimally affected beyond the additional mass of the accumulate and further reduce the energy density away from the 400 Wh/kg figure which is the minimum target of most contemporary battery development.

In some embodiments, the present disclosure performs heat transfer for battery sells in a cohesive system with the following thermal mitigations. First, the system allows rapid and distributed thermal energy to be added to the battery cells through direct conduction at a high mass efficiency (e.g., over 2.5 kW/kg) while not allowing overheating of the battery cells or impeding heat rejection during cooling. Second, the system reduces waste heat that needs to be rejected. Third, the system transfers waste heat as short of a distance as possible. Fourth, the system integrates heat generating elements into their own mechanism for cooling. Fifth, the system leverages turbulent airflow inside an intercooled battery chamber to maximize effective transfer of heat per unit air. Sixth, the system maximizes exhaust air temperature gain to reduce the active energy required to effect cooling. Seventh, the system re-uses exhaust air and bleeds air from the cooling system to selectively normalize cooling effects throughout a volume. Eighth, the system re-uses exhaust air and bleeds air from the cooling system to selectively cool other components of other systems. Ninth, the system filters incoming low pressure air such that it rejects dust and debris. Tenth, the system passes incoming air through a P-static controlled chassis to reduce the electrical charge of incoming air and debris from accumulating onto internal surfaces.

In some embodiments, as described above, the present system aims to reduce generated heat. The system minimizes generated heat by the battery by minimizing cell-internal, junction, and conductor resistance in the high current path. This is performed by intentionally reducing the specific energy density of the battery, thereby creating a specialized intercooled arrangement of battery cells that are connected by ultra-low resistance mechanically terminated bus bars that are also heat sinks. In some embodiments of the present disclosure, battery cells are designed to be stout and narrow with thick electrodes. This design maximizes the thermal conductivity for generated heat inside the cells to the outside case of the cells, and further through the electrically conductive path to specialized heat rejecting bus bars through a wide and robust mechanical termination. The battery cells are arranged to minimize the total internal resistance of each cell, reduce the total amount of waste generated heat, and maximize thermal paths to reject heat at the expense of energy density. A battery state of charge swings are designed to maintain operation in a low dQ/dE region of the battery during discharge and during charge. dQ/dE is the rate at which the Heat gain changes with an amount of state of charge swing. Both low State of Charge and high State of charge outside of specific bounds have a large increase in dQ/dE. A person of ordinary skill in the art can recognize that dQ represents an heat added to the system and dE is the change in energy of the system. Maintaining operation in this low dQ/dE region is a tradeoff between higher energy density of the cell and better thermal management, benefits in charge rate, and cycle life of the battery.

In some embodiments, a battery architecture includes a plurality of battery cells. Each battery cell is a pouch-type battery cell that contains the lithium chemistry. The thickness and aspect ratio of the conductive leads are non-standard to aid thermal conduction out of the cell.

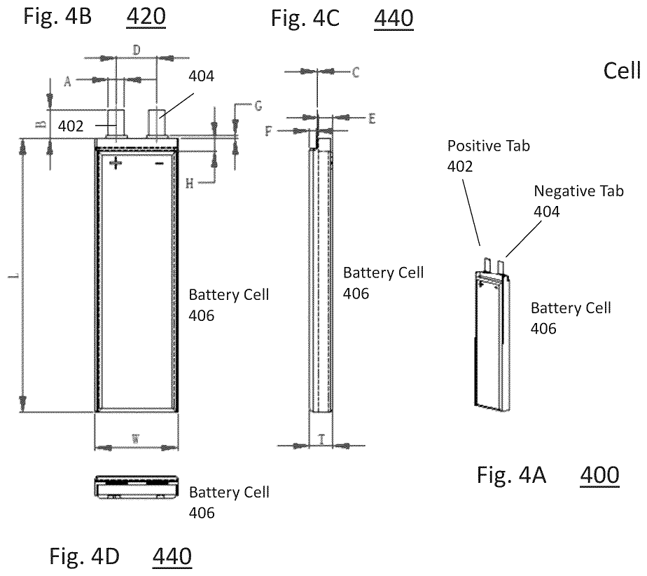

FIGS. 4A-B are diagrams illustrating various views of an example embodiment of an individual battery cell of the present disclosure. FIG. 4A is a diagram 400 illustrating an isometric view of a battery cell 406 including a positive lead 402 and negative lead 404. FIG. 4B is a diagram 420 illustrating a front view of a battery cell 406 including a positive lead 402 and negative lead 404. FIG. 4C is a diagram 440 illustrating a side view of a battery cell 406. FIG. 4D is a diagram 460 illustrating a top view of the battery cell 406.

FIGS. 4B-4C further illustrate respective distances A, B, C, D, E, F, G, H, I, T (Thickness), W (Width), and L (Length). The below Table 1 illustrates example size ranges for these distances. A person of ordinary skill in the art can recognize that other distances can be used for any of the distances. Further, a person of ordinary skill in the art can recognize that ratios of some or all of the below distances can be used in some embodiments, while varying some or all of the distances of the cell.

TABLE 1

| Specification | Size Range | |
|---|---|---|
| Thickness (T) | 7.4 ± 0.3 | mm |
| Width (W) | 42 ± 1.0 | mm |
| Length (L) | 143.5 ± 1.0 | mm |
| Distance between 2 leads (D) | 21.0 ± 1.5 | mm |
| Lead Width (A) | 15 ± 0.2 | mm |
| Lead Thickness (C) | 0.2 | mm |
| Lead Length (B) | 11.0 ± 1.5 | mm |
| Sealant Length (G) | 0.2 mm-2.0 mm | |
| Sealing Width (H) | 5.0 ± 0.2 | mm |
| First Deep Groove | 6.3 | mm |
| Second Deep Groove | 0.6 | mm |

In some embodiments, the cell weighs 99 grams or less.

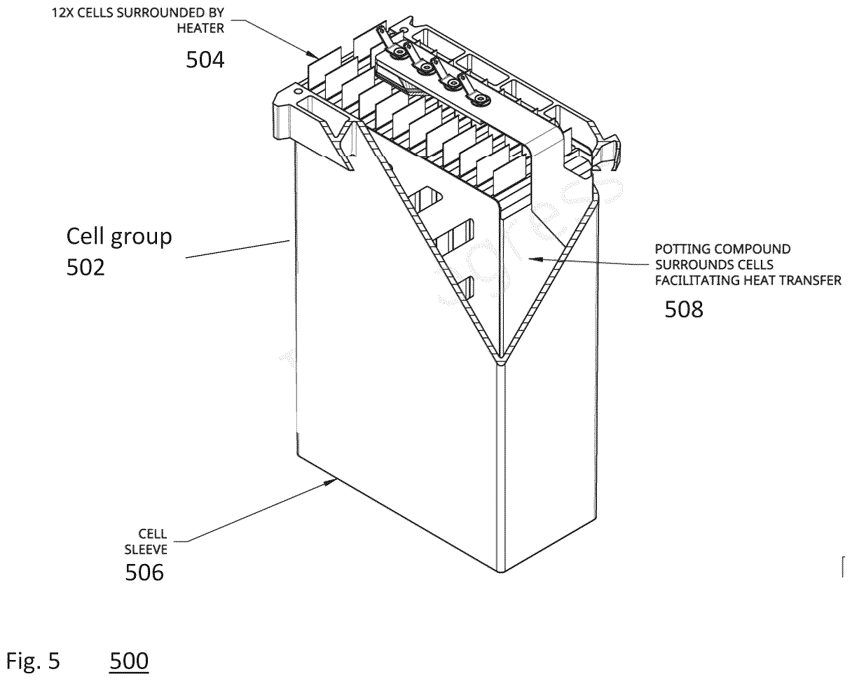

FIG. 5 is a diagram 500 illustrating some example embodiments of a cell module employed by the present disclosure. In some embodiments, a group or cell module 502 includes multiple battery cells described above. In some embodiments, the group includes 12 battery cells 504, however, a person of ordinary skill in the art can recognize that other quantities of cells can be used. The group further includes a temperature sensor (not shown) and a customized wraparound heating element 508. The cells of the group are potted within a thin-walled plastic cell sleeve 506 using thermally conductive epoxy 508, which provides a conductive thermal path into and out of the cells. The epoxy (e.g., potting compound) 508 distributes the temperature between cells 504 and within a single cell. In addition, special care is taken during construction to eliminate bubbles in the epoxy 508 that would otherwise result in hot spots on the cells 504. The heating element heats specific areas of the cell that are known to be colder in operation. In some embodiments, the cells 504 in a group are connected in parallel.

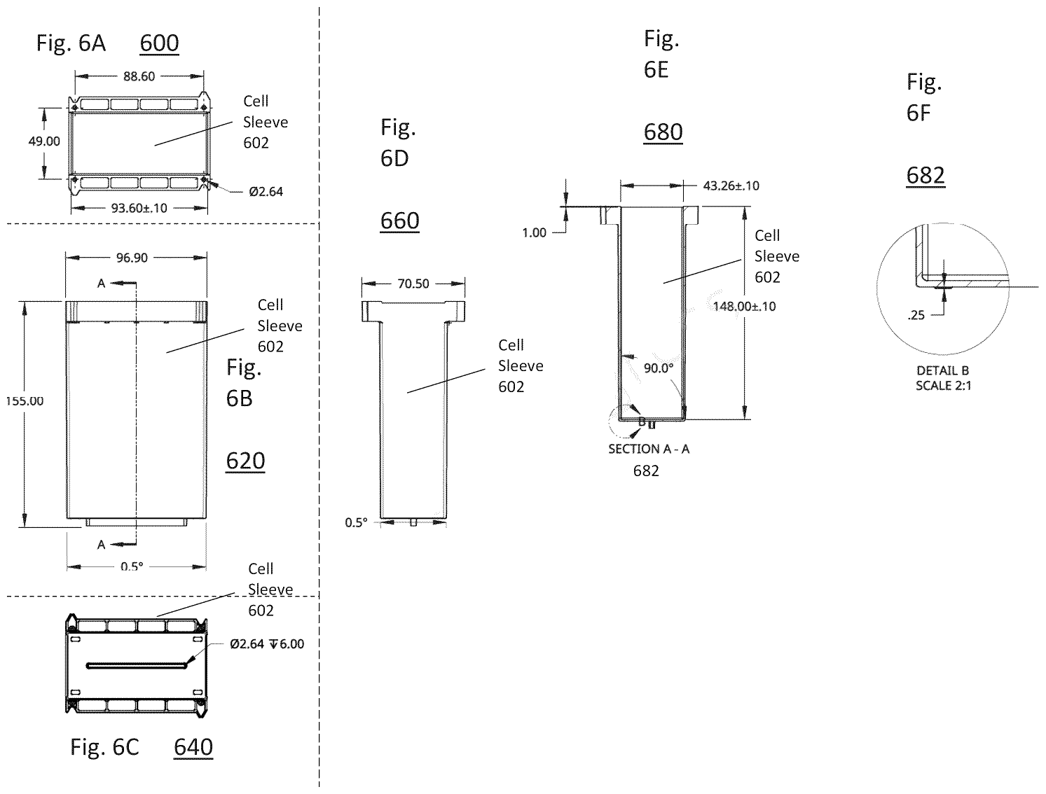

FIGS. 6A-F are diagrams 600, 620, 640, 660, 680, and 690 illustrating some example embodiments of a cell sleeve 602, such as cell sleeve 506 illustrated by FIG. 5. In relation to FIG. 6A, diagram 600 illustrates some example embodiments of a cell sleeve 602 and corresponding example dimensions shown from a bottom view. FIG. 6B is a diagram 620 illustrates some example embodiments of a cell sleeve 602 and corresponding example dimensions shown from a side view. FIG. 6C is a diagram 640 illustrating some example embodiments of a cell sleeve 602 and corresponding example dimensions shown from a top view. FIG. 6D is a diagram 660 illustrating some example embodiments of a cell sleeve 602 and corresponding example dimensions shown from an orthogonal side view. FIG. 6E is a diagram 680 illustrating an example embodiment of the cell sleeve 602 and corresponding example dimensions shown from the orthogonal side view. FIG. 6F is a diagram 682 illustrating section A-A 682 of the cell sleeve 602 and corresponding example dimensions.

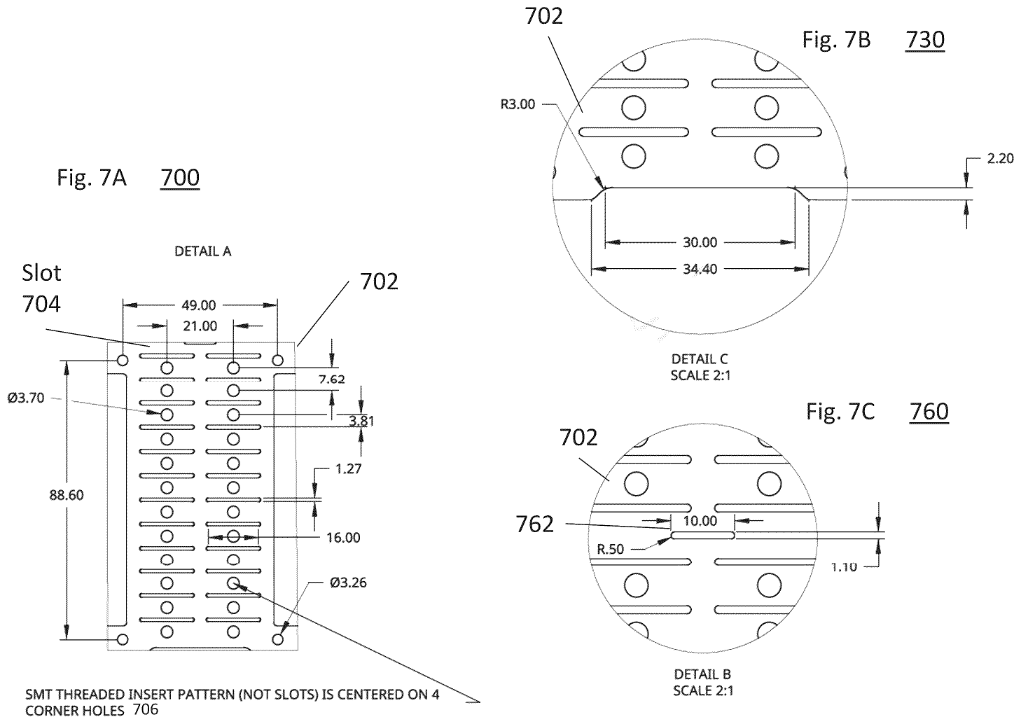

FIGS. 7A-C are diagrams 700, 730, 760 illustrating some example embodiments of a printed circuit board 702 used in a battery module of the present disclosure. A cell module is a modular grouping of multiple battery cells within a cell sleeve. In some embodiments, the cell module includes a battery heater. As illustrated by FIG. 7A, the battery module includes 24 slots 704 for each of the 24 battery leads of the 12 battery cells. The printed circuit board 702 for the battery module further includes a threaded insert pattern to mount the bus bar against the folded over leads. The threaded insert patterns 706 are illustrated by the circular holes disposed between each slot, and are disposed to electrically and thermally link the cell leads to the bus bars upon a threaded securing device being inserted and soldered. In some embodiments, the threaded insert patterns are disposed to accept a mounting device, such as a screw and secure a bus bar against the PCB 702. In some embodiments, the threaded insert patterns can accept a soldering material to further secure the bus bar against the printed circuit board 702. In some embodiments, the leads or tabs that are inserted through the slots are folded over against the battery module 702 before securing the bus bar. Folding the leads provides more surface area of contact between the battery module and the bus bar, thereby maximizing thermal and electrical conductivity from the cell to the bus bar.

FIG. 7B is a diagram 730 illustrating an example embodiment of dimensions of the printed circuit board 702 of the cell module.

FIG. 7C is a diagram 760 illustrating some example embodiments of dimensions of the printed circuit board 702 of the cell module.

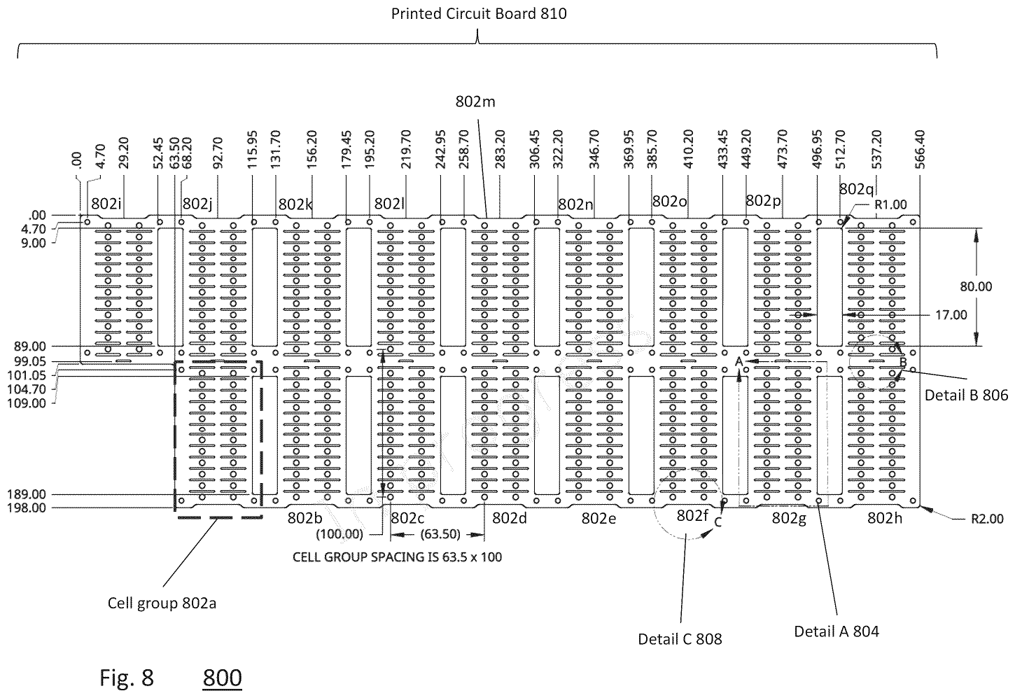

FIG. 8 is a diagram 800 illustrating some example embodiments of a printed circuit board 810 of a battery module. In some embodiments, the printed circuit board 810 of the battery module includes respective areas multiple cell modules 802a-q to be mounted and multiple busbars (not shown). In some embodiments, the battery module 810 contains mountings for 17 cell modules 802a-q, 15 busbars (not shown) and a large, a custom designed printed circuit board (PCB) having (1) heavy copper pours, (2) slots (e.g., for the positive and negative leads of each battery cell), and (3) threaded inserts that combine with machine screws to mechanically link the bus bars to the PCB and provide clamping force to electrically and thermally link the cell leads into the busbars. In some embodiments, battery modules are connected to other battery modules in series.

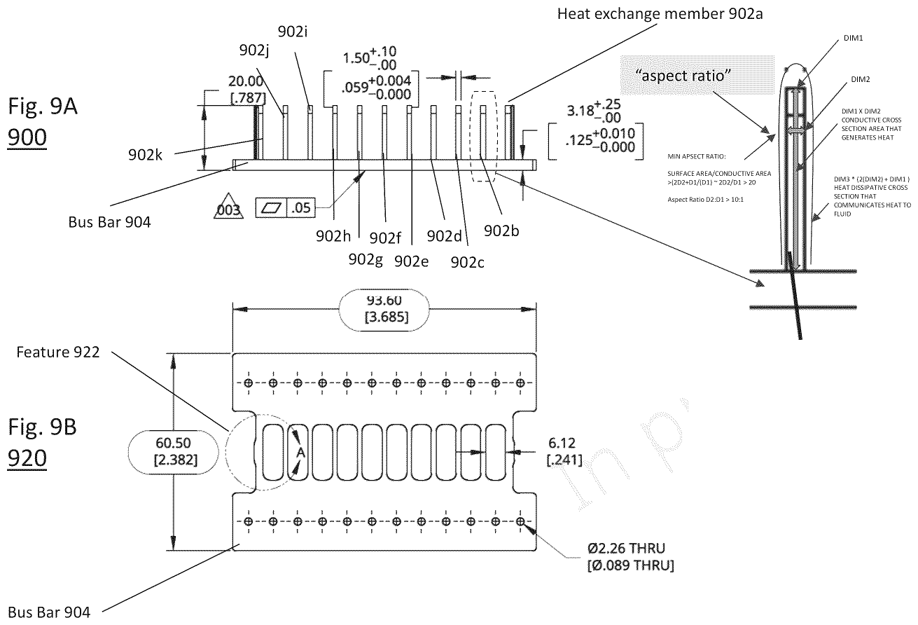

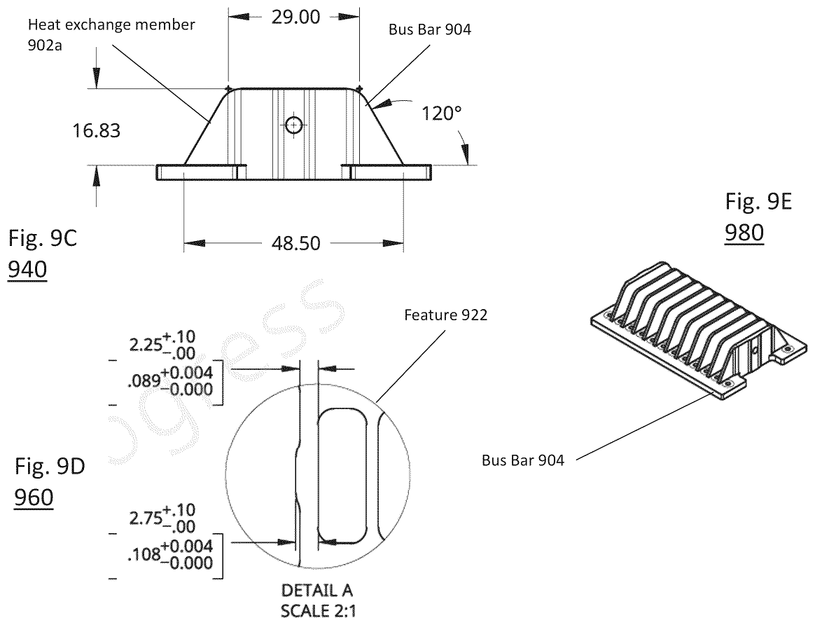

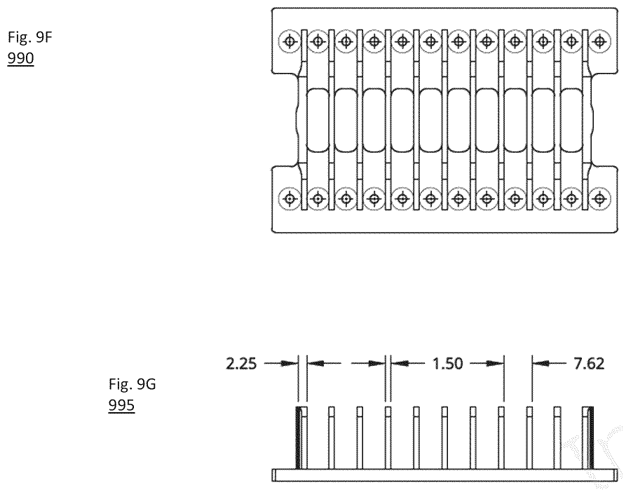

FIGS. 9A-G are diagrams 900, 920, 940, 960, 980, 990, and 995 illustrating some example embodiments of a bus bar 904. FIG. 9A is a diagram 900 illustrating some example embodiments of a side view of the bus bar 904. In some embodiments, busbars both carry electrical current and thermally conduct heat to the surrounding working fluid (e.g., air). The bus bar is disposed to be mounted against the printed circuit board of the battery cells of the battery modules, and further to electrically couple a first battery cell of the battery module to a second battery cell of the battery module in series. The bus bar includes a flat portion (e.g., a rectangular prism portion) that is configured to be in contact with the PCB and the battery cell lead(s). The bus bar's thermal transfer to the working fluid is enhanced by its heat exchange members 902a-k (e.g., integrated heat sink fins). The heat exchange members 902a-k have an aspect ratio to maximize heat exchange with the working fluid. In some embodiments, long, thin, structure of the heat exchange members 902a-k provides for more contact with the working fluid (e.g., air) to remove heat from the heat sink and therefore the battery. In some embodiments, the heat exchange members 902a-k have an aspect ratio of about 2:5. The PCB 810 also provides mechanical stiffness/structure to the module and a mounting surface for the busbars.

FIG. 9A further illustrates an enlargement of heat exchange member 902b, illustrating three dimensions of the heat exchange member 902b. A person of ordinary skill in the art can recognize that these dimensions can be applied to the other heat exchange members 902a-k. A DIM1×DIM2 conductive cross section generates heat. However, heat is dissipative across the entire surface area, which can be expressed as DIM3*(2(DIM2)+DIM1). The minimum aspect ratio can be expressed as surface area/conductive area, which is greater than 20.

FIG. 9B is a diagram 920 illustrating some example embodiments of a bottom view of the bus bar 904, including a plurality of vent holes 924. Feature 922 is illustrated in further detail with relation to FIG. 9D. The vent holes 924 allow air exchange from below to above the bus bar.

FIG. 9C is a diagram 940 illustrating some example embodiments of a side view of the bus bar 904. In particular, FIG. 9C illustrates a side or profile view of a heat exchange member 902 of the bus bar 904. In some embodiments, the heating exchange member 902a is trapezoidal. In some embodiments, the heat exchange members 902a-k are predominantly trapezoidal, where predominantly trapezoidal refers to a shape that has at least 80%, 85%, 90%, 95%, 96%, 97%, 98%, or 99% of its surface area on that respective side within a shape of a trapezoid. In some embodiments, the heat exchange members 902a-k can have other non-trapezoidal shapes that have an aspect ratio of about 2:5. The heat exchange members 902a-k can further have an aspect ratio of height to width of about at least 10:1 In some embodiments, the heat exchange members can have 902a-k can be rectangular, triangular, pentagonal, hexagonal, or other polygonal shape.

FIG. 9D is a diagram 960 illustrating some example embodiments and example measurements of the feature 922 illustrated in FIG. 9B.

FIG. 9E is a diagram 980 illustrating some example embodiments of an isometric view of the bus bar 904.

FIGS. 9F and 9G are diagrams 990 and 995 respectively illustrating a top and side view of a bus bar and corresponding dimensions of the same.

In some embodiments, FIGS. 9A-9G illustrate that the base of the heat exchange members, in a trapezoidal embodiment are 48.5 mm, the top is 29.00 mm, and the height is 16.83 mm with a 120 degree outer angle. The heat exchange members can be about 2.25 mm, about 1.50 mm, or about 1.50-2.25 mm.

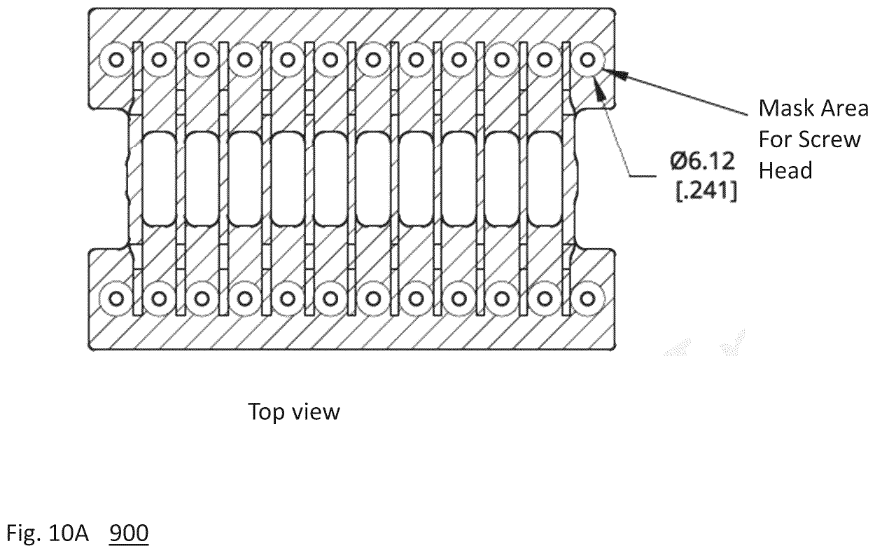

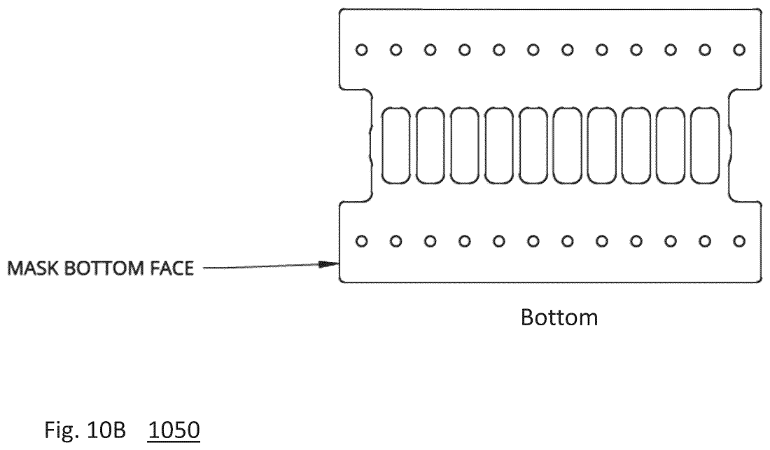

FIG. 10A is a diagram 1000 illustrating some example embodiments of a bottom view of the bus bar.

FIG. 10B is a diagram 1050 illustrating some example embodiments of a bottom view of a bus bar.

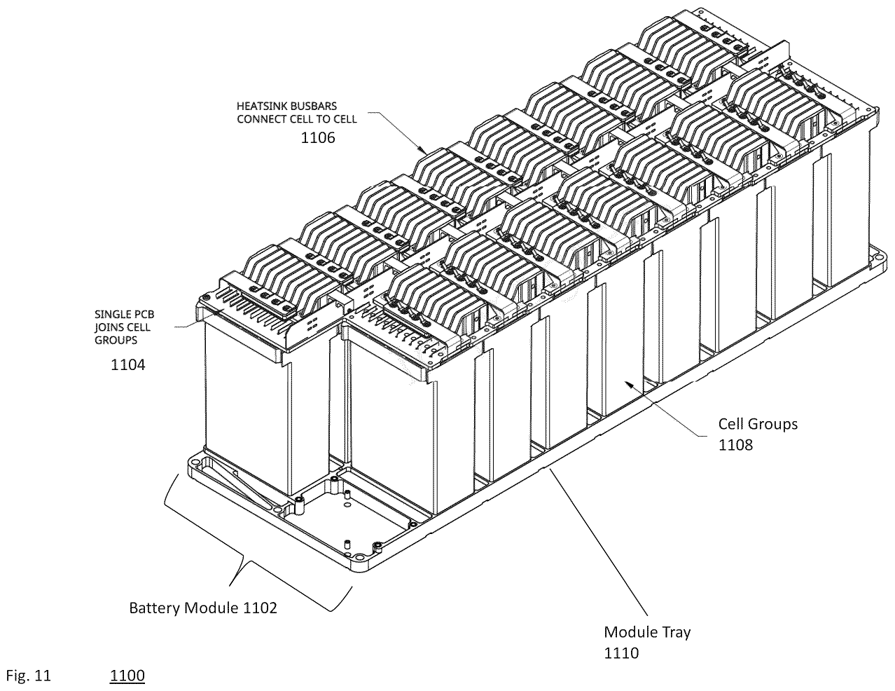

FIG. 11 is a diagram 1100 illustrating some example embodiments of an isometric view of a battery module 1102 of the present disclosure. The battery module 1102 includes a plurality of cell modules 1108. The cell modules 1108 each removably coupled to a module tray 1110 (so a single cell can be removed/replaced while the remaining cell modules 108 remain engaged with the battery module 1102. A plurality of heatsink busbars 1106, or busbars 1106, connect battery cells of the cell module in series, while also dissipating heat from each battery. Each heatsink can be removably coupled to the underlying cell module.

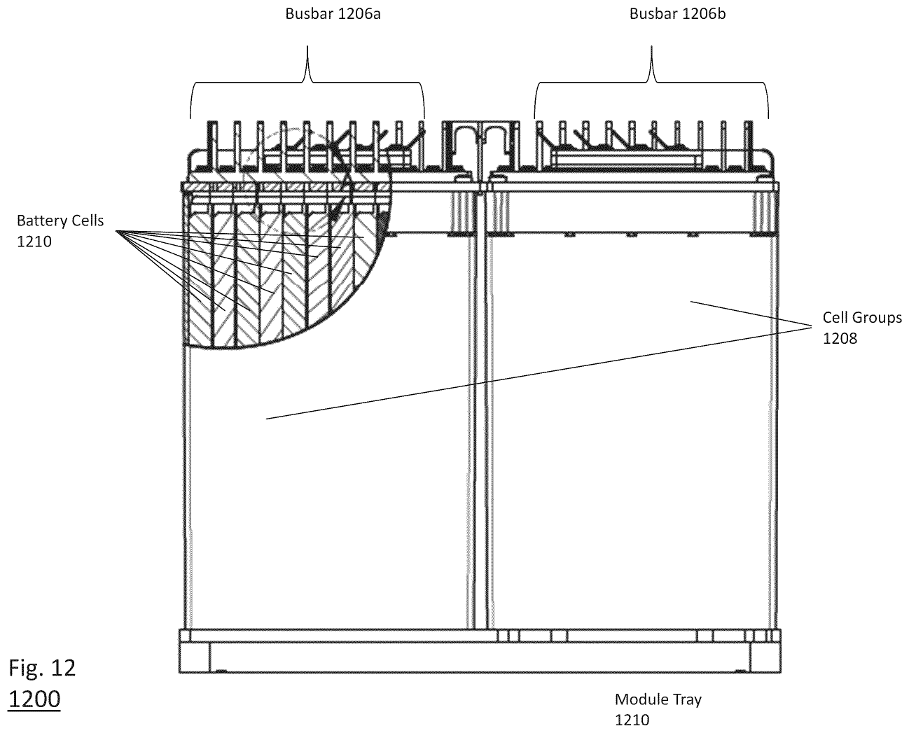

FIG. 12 is a diagram 1200 illustrating some example embodiments of a side view of a battery module 1202. Cell modules 1208 are affixed to a module tray 1208. Each individual cell module includes a plurality of battery cells 1210 which have positive and negative leads that are electrically and thermally coupled to respective busbars 1206a and 1206b. In the exemplary embodiment shown, the busbar is formed from a plurality (e.g. 10) upwardly extending fins that are equidistantly spaced, and of equivalent dimensions (e.g. width, height), however alternative geometries and configurations are within the scope of the present disclosure.

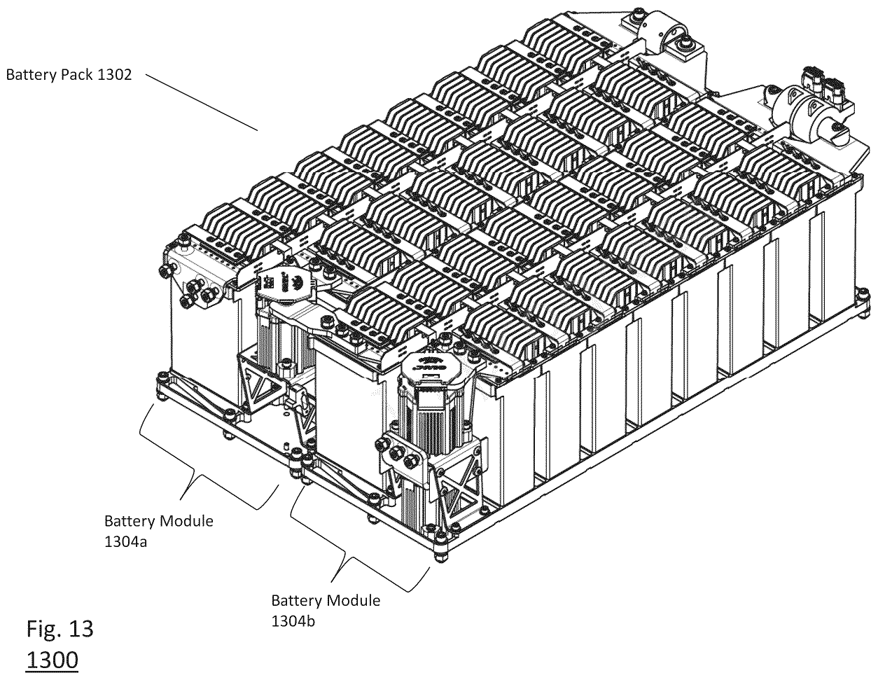

FIG. 13 is a diagram illustrating an example of a battery pack 1302 including a first battery module 1304a and a second battery module 1304b. In some embodiments, a pack 1302, sometimes referred to as a battery pack 1302, includes multiple battery modules 1304a-b as described above, having the busbars, contactors, monitoring electronics, and wiring harnesses contained therein each battery module 1304a-b. In some embodiments, there are two modules 1304a-b in a pack, but a person of ordinary skill in the art can recognize that other quantities of battery modules 1304a-b can be employed. In some embodiments, a battery pack 1302 includes 408 cells, with 34 cell modules connected in series, each cell module having 12 cells connected in parallel. However, a person of ordinary skill in the art can recognize that other quantities can be employed. By combining two battery modules 1304a-b into a battery pack 1302, the airflow channels of the module can be aligned so that an airflow channel of the first battery module 1304a is aligned with an airflow channel of the second battery module 1304b. In some embodiments, the battery modules can be connected by a non-heat conductive bus bar.

In some embodiments, the battery pack(s) 1302 and battery modules 1304a-b are designed and spaced to allow airflow through the battery as a whole (e.g., intercooling). The intercooling is performed on sides of each group (e.g., four sides) and across the fins of the busbars. Intercooling rejects heat into the environment via forced convection of filtered, ambient air. The fans and filters are considered a part of the aircraft and provide coordinated cooling to the battery and other components in the core of the aircraft. Some embodiments of airflow is shown in relation to FIGS. 1-3 and described above.

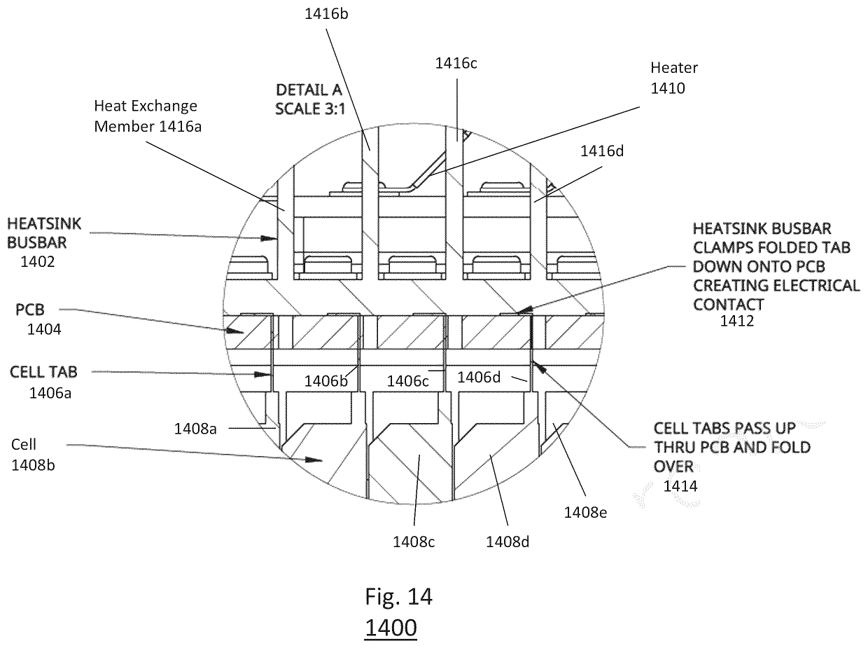

FIG. 14 is a diagram 1400 illustrating a cross-sectional view of a busbar 1402 affixed to a plurality of cells 1408a-e. The plurality of cells 1408a-d each have a corresponding cell lead 1406a-d, where the cell lead for cell 1408e is not shown. As is described herein, each cell 1408a-e includes a positive lead and a negative lead, which can each take the form of separate leads as shown by FIG. 4. However, for simplicity and to illustrate the disposition of the bus bar and the plurality of cells, FIG. 14 illustrates just one lead per cell.

In some embodiments, the cell leads 1406a-d are disposed to be orthogonal from the surface of the respective cell 1406a-e. A printed circuit board (PCB) 1404 having slots therein is disposed such that each cell lead 1406a-d resides in a respective slot of the PCB 1404. The cell leads 1406a-d pass up and through slots of the PCB 1404, and are folded over the PCB 1414. In some embodiments, the cell leads are disposed to contact the PCB 1404 within the slots. In some embodiments, the cell leads 1406a-d are disposed to contact the PCB 1404 in the folded over portion of the lead. In some embodiments, the cell leads are disposed to contact the PCB 1404 within the slots and in the folded over portion of the lead.

In some embodiments, the busbar 1402, or heatsink busbar 1402, is clamped over the folded lead onto the PCB, thereby creating an electrical contact with the leads 1406a-d and the busbar 1402. In some embodiments, the present system transfers the generated heat deep within the battery cells to surfaces that can reject the heat through a short, thermally conductive path. In the main body of the cells, thick electrode plates within the battery allow for high thermal conductivity within a planar surface of the battery. The busbar 1402 includes a large surface area to facilitate increased thermal transfer from the cell to the busbar. The bus bar 1402 further includes heat exchange members 1416a-d that further facilitate increased thermal transfer from the busbar to the surrounding working fluid (e.g., air) by increasing the surface area of the busbar with the working fluid. In addition, a heater 1410 is folded over the top of the bus bar.

The short path allows for a low temperature gradient during heat transfer. In addition, a highly thermally conductive graphene material between battery cells allows an additional, indirect, but more highly thermally conductive path to additional surface areas surrounding the cell.

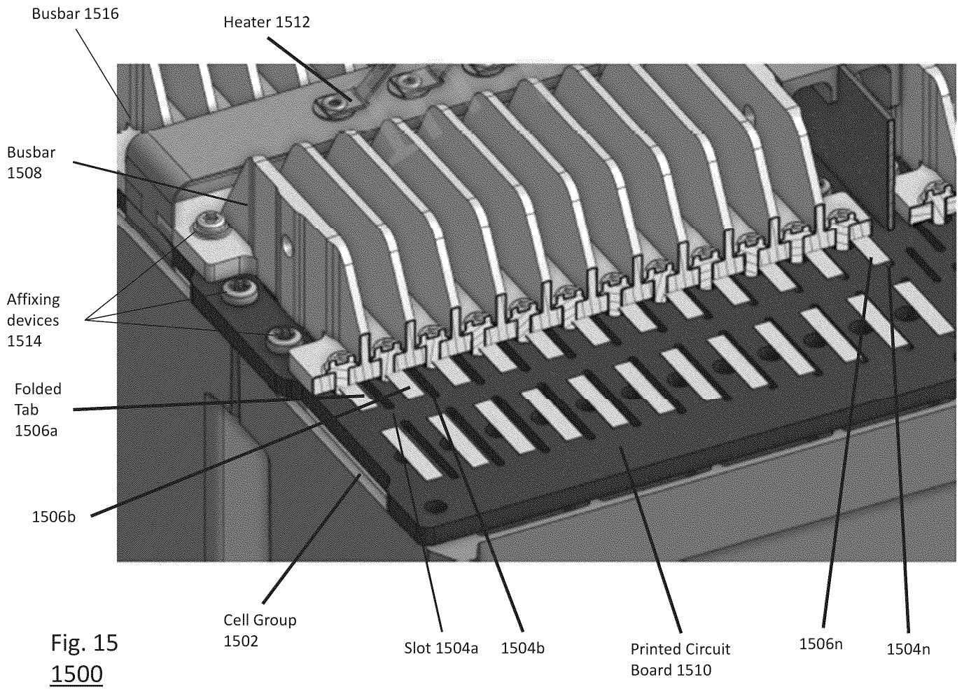

FIG. 15 is a diagram 1500 illustrating an example embodiment of the busbar 1508 disposed against a cell module 1502. The cell module 1502 includes a plurality of slots 1504a-n having battery cell leads protruding through the respective slots, resulting in a folded lead 1506a-n being folded against the PCB 1510. The busbar 1508 is mounted on top of the printed circuit board 1510 and the folded leads 1506a-n, thereby creating an electrical connection with the busbar 1508 and the folded leads 1506a-n. The connection further facilitates heat transfer from the folded leads 1506a-n transferring heat from their respective battery cells of the cell module 1502 to the planar surface of the busbar that is in contact with the folded leads 1506a-n. The heat then transfers within the busbar to the heat exchange members, which have a large surface area for exchanging the heat with the surrounding working fluid.

In some embodiments, a heater 1512 is disposed against the busbar 1508.

In some embodiments, screws or other affixing devices can be employed to hold the busbar 1508 against the folded leads 1506a-n and the PCB 1510. In some embodiments, adjacent busbars can be considered bus bars that are affixed to adjacent cell modules. In some embodiments, adjacent busbars can be considered bus bars are connected to the oppositely charged leads of a same cell module (e.g., a first busbar connected to the positive lead(s) of a particular cell module and a second busbar connected to the negative lead(s) of the particular cell module).

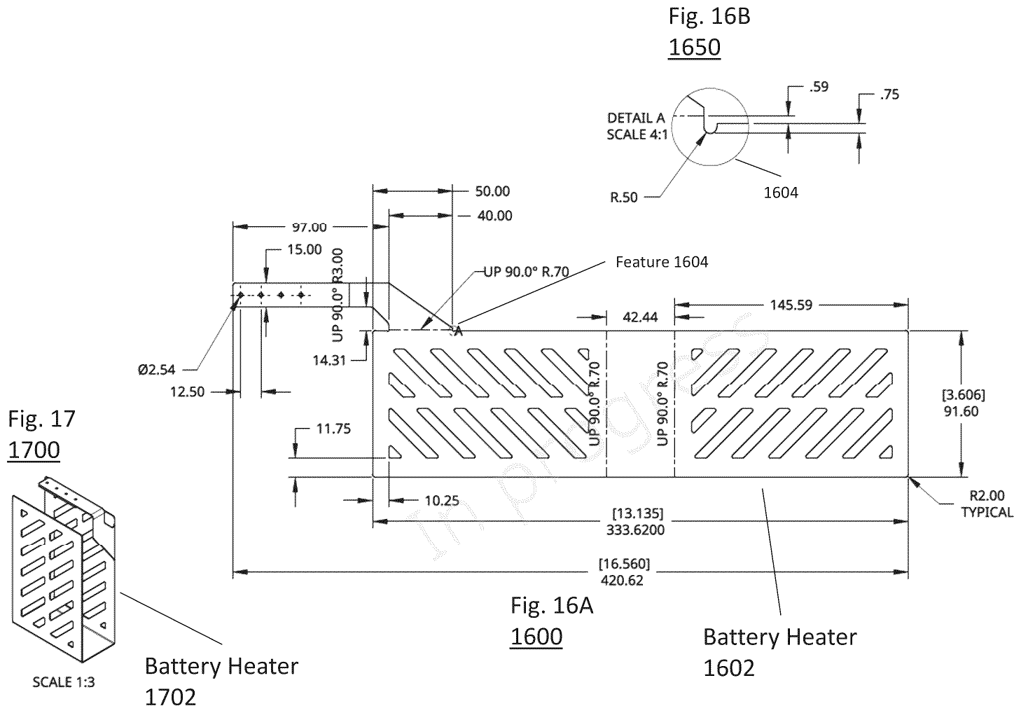

FIG. 16A is a diagram 1600 illustrating an embodiment of an unfolded schematic of a battery heater 1602. In some embodiments, the battery heater 1602 can be disposed within a cell sleeve, such as the cell sleeve illustrated in FIGS. 5 and 6A-F. In some embodiments, the battery heater 1602 can be disposed outside of a cell sleeve, such as the cell sleeve illustrated in FIGS. 5 and 6A-F. FIG. 16B is a diagram 1650 illustrating an example embodiment of feature 1604 illustrated by FIG. 16A.

FIG. 17 is a diagram 1700 illustrating some embodiments of an isometric view of a battery heater 1702. FIG. 17 illustrates the battery heater 1702 in a deployable position.

In some embodiments, an internal thermal path terminates at a fractional millimeter thin battery heater. The internal thermal path provides minimal thermal impedance through, but higher thermal dispersion within plane of the internal electrode plates within the battery to allow a higher heated surface area inside the intercooled part of the cell to reject heat. The internal thermal path between the heating elements and the cells allow for an efficient transfer of energy from the heater, when active, to the cell internal structure without losing an excess of heat to the intercooler.

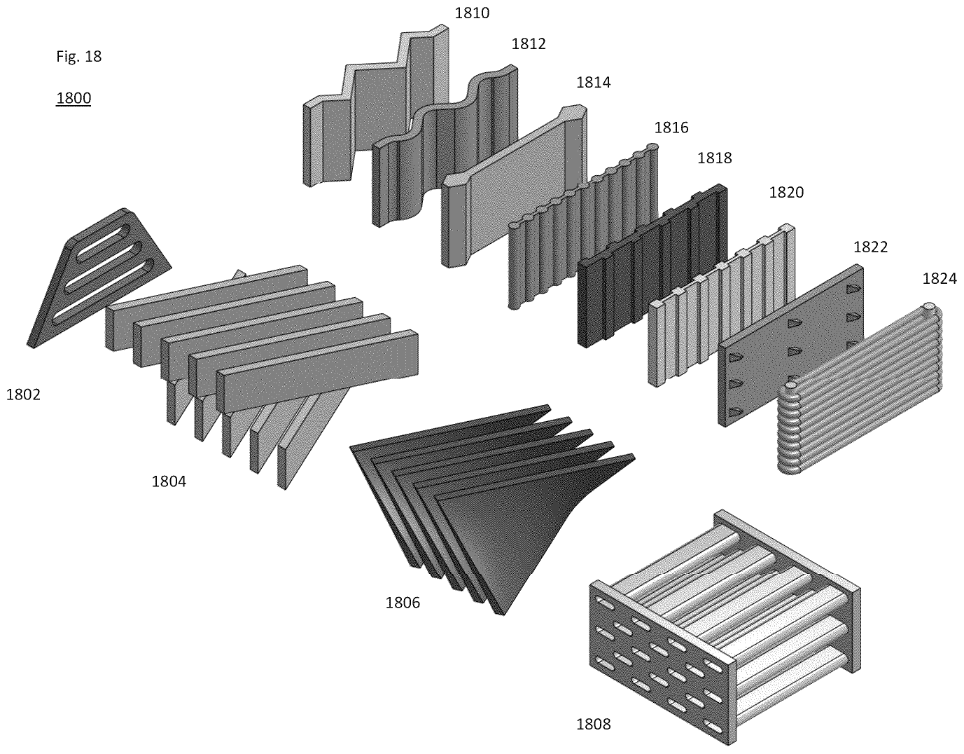

FIG. 18 is a diagram 1800 illustrating some example embodiments of shapes or designs of heat exchange members. In some embodiments, fins are an example embodiment of a geometry. In some embodiments, the geometry can be more complex, such as sparse matrix three-dimensional (3D) geometry or complex surfaces that present a high surface area against the fluid, with a Reynolds number that minimizes laminar flow of the fluid.

In some embodiments, the trapezoidal shape normalizes the current density of the bus bar as the vertical fins begin to overlap with the horizontal mating surface. The trapezoidal shape normalizes around 1.8 A/mm² current density. In some embodiments, the shape of the heat exchange members can be different based on different specific heat exchange embodiments. In some embodiments, the heat exchange members can include a more complex 3D structure of the fins, a sparse matrix, wirewound, complex surfaces, etc. In some embodiments, if the system were to accept lower current density in certain locations at the expense of wasted mass, then the heat exchange members can be rectangular, spherical, more rectangular, or more spherical.

In some embodiments, heat exchange member 1802 is predominantly trapezoidal with slots. The slots of heat exchange member 1802 can provide additional (e.g. more tortuous) routes for the working fluid to make contact with the heat exchange member 1802 and remove heat from the bus bar. In some embodiments the slots are exclusively linear surfaces; in some embodiments the slots can include non-linear (e.g. curved) surfaces with an arcuate flow path.

In some embodiments, heat exchange member 1804 is a first plurality of parallel rectangular members disposed under a second plurality of rectangular members, a second plurality of parallel rectangular members, where the second plurality of rectangular members is disposed at an angle relative to the first plurality of rectangular members.

In some embodiments, heat exchange member 1806 is a curved, triangular member. In some embodiments, the triangular plane being curved allows move contact with a working fluid.

In some embodiments, heat exchange member 1808 includes a first rectangular member and a second rectangular member disposed parallel from each other and connected by a plurality of pillars. In some embodiments, the rectangular members include vent holes.

In some embodiments, a heat exchange member 1810 includes multiple alternative V-shaped patterns. The V-shaped pattern allows for different working fluid flows to make contact with the heat exchange member 1810.

In some embodiments, a heat exchange member includes a sine-wave, cosine-wave, or curvy pattern. The curvy pattern allows for different working fluid flows to make contact with the heat exchange member 1812.

In some embodiments, the heat exchange member 1814 is rectangular having two pillars at the end. In some embodiments, the pillars can be circular, hexagonal, rectangular, pentagonal, or other shape.

In some embodiments, the heat exchange members 1816 is a series of circular pillars connected by rectangular sections.

In some embodiments, the heat exchange members 1818 is a series of rectangular members that protrude from alternating sides of the rectangular member.

In some embodiments, the heat exchange member 1820 is a rectangular member having a series of square pillars disposed along the center of the rectangular member.

In some embodiments, the heat exchange member 1822 is a rectangular member having pyramidal protrusions from the face of the rectangle.

In some embodiments, the heat exchange member 1824 is a series of vertically stacked bands.

In some embodiments, the heater also compensates for a non-uniform generation of heat within the cell by concentrating heat power density to area of the cells that naturally heat the least (e.g., a side of the cell furthest from the exposed electrodes). Having efficient use of the heaters allows for more efficient charging and discharging of the battery, lower thermal gradients, and slower rates of change. This provides for more precise control and predictable behavior and allows the battery to be operated at lower ambient temperatures as well as higher ambient and actual temperatures.

In some embodiments, most of the waste heat is generated in the ⅔rds of the battery cell closest to the exposed electrodes (e.g., the “top” of the cell). In some embodiments, the maximum waste heat point can be approximately 75% along a dimension of the cell closest to the electrodes. Additional thermal paths are provided to normalize the cell internal temperature. Using the thick and wide electrodes, a special heavy copper bus bar printed circuit board with slots that allow the electrodes to pass through is applied to the cell groups. This heavy copper circuit board allows for additional heat capacity and thermal distribution as close as possible to the battery to capture any heat transferred by conduction and acts as a mounting point for top mounted bus bars.

In some embodiments, leads are folded over to maximize surface contact, which also maximizes the electrical and thermal conductivity from the leads of the bus bars. This contact surface spans the entire top surface of the battery electrodes. The bus bars are made of a highly conductive alloy of aluminum. The aluminum acts as a large thermal mass to absorb thermal energy impulses, minimizes weight, and maximizes bulk. The bus bars are machined into heat sinks with large vent holes to allow forced air to vent up through the bus bars and flow over the heat exchanger fins. These bus bars work with air flowing up vertically and air directed along its fins, thereby creating a secondary heat transfer surface larger than the battery itself.

In some embodiments, the system rejects generated heat. Filtered and discharged ambient air is controlled and actively forced by command of the battery system into the battery. The air is injected through opposing sides of the intercooled section of the battery to break laminar flow and create a high pressure region of turbulent air that impinges over the heated surfaces many times instead of passing over it. This same air is then recycled and reused in multiple stages to maximize the energy transferred to the air by successively hotter and less temperature sensitive elements. This air is only allowed to exit through the special heat-sink geometry as mentioned above at high velocity. The exhaust air then is recycled as it is restricted further to pass over all remaining heat exchanging features along the cooling fins. After accumulating several degrees Centigrade in temperature rise, ejecting several thousand watts of waste heat, the exhaust air leaves the central integrated intercooled section of the battery. The bleed air and exhaust air is used to cool less-thermally sensitive elements in and around the battery cells, and to pressurize the area around the battery to protect against dust and debris, before being discharged again and ejected.

What is claimed is:

1. A battery system comprising:
a plurality of battery cell modules, each battery cell module having a positive lead and a negative lead; and
a bus bar disposed to be in electrical communication with a positive lead of a first battery cell module of the plurality of battery cell modules and a negative lead of a second battery cell module of the plurality of battery cell modules, the bus bar including a plurality of heat exchange members in thermal communication with a surrounding working fluid;
wherein each of the plurality of heat exchange members have a first dimension and a second dimension, the first dimension being at least a distance between the positive lead and the negative lead, the second dimension being orthogonal to the first dimension and at least a distance at least a distance from a bottom of a heat exchange member the plurality of heat exchange members in contact with the positive and negative leads to a top of the heat exchange member;
wherein the thermal communication with the working fluid occurs over the length of the first dimension;
wherein a ratio of the first dimension to the second dimension is around at least 2:5.

2. The battery system of claim 1, wherein the positive lead and the negative lead are in thermal communication with the bus bar and in electrical communication with the bus bar.

3. The battery system of claim 1, wherein each battery cell module further comprises a plurality of battery cells electrically connected in parallel by a respective positive lead and negative lead of each battery cell of the plurality of battery cells.

4. The battery system of claim 3, wherein the respective positive lead and respective negative lead are disposed to thermally conduct heat from each battery cell module to the bus bar, the heat transferred being at least 90 Watts.

5. The battery system of claim 3, wherein the bus bar is a first bus bar, the battery system further comprising:
a second bus bar, the second bus bar disposed to be in electrical communication with a positive lead of the second battery cell module of the plurality of battery cell modules and a negative lead of a third battery cell module of the plurality of battery cell modules.

6. The battery system of claim 1, wherein each of the plurality of battery cell modules are connected in series.

7. The battery system of claim 1, wherein the plurality of heat exchange members are fins.

8. The battery system of claim 1, wherein the bus bar is made of at least one of aluminum and copper.

9. The battery system of claim 1, wherein the bus bar includes a plurality of vent holes enabling air flow from a bottom of a surface of the bus bar to a top of the surface of the bus bar.

10. The battery system of claim 1, further comprising a temperature sensor.

11. The battery system of claim 1, further comprising a heating element disposed around the plurality of battery cell modules and configured to warm selected areas of the battery cell modules.

12. The battery system of claim 1, wherein each of the plurality of heat exchange members is predominantly trapezoidal.

13. The battery system of claim 1, wherein the bus bar has a thermal conductivity of at least 200 Watt per meter Kelvin.

14. The battery system of claim 1, wherein the positive lead and the negative lead have a thermal conductivity of 200 Watt per meter Kelvin.

15. The battery system of claim 1, further comprising:
a printed circuit board including a plurality of slots, the positive lead and negative lead of each battery cell disposed within a respective slot of the plurality of slots;
wherein the printed circuit board includes a first plurality of mounting holes;
wherein the bus bar includes a second plurality of mounting holes, the first plurality of mounting holes disposed to align with the second plurality of mounting holes;
wherein the bus bar is disposed to be in contact with the positive lead of the first battery cell module of the plurality of battery cell modules and the negative lead of the second battery cell module of the plurality of battery cell modules upon being mounted to the printed circuit board, the positive lead and the negative lead being disposed between the bus bar and the printed circuit board.

16. A battery module comprising:
a plurality of the battery systems of claim 1;
a bus bar disposed to connect a first battery system of the plurality of battery systems to a second battery system of the plurality of battery systems;
an electronics monitoring module;
a wiring harness; and
a contactor.

17. A bus bar comprising:
a thermal mass that thermally conducts at least 100 W of heat and electrically conducts at least 1.8 Amps per square millimeter of electricity, wherein the thermal mass includes:
a rectangular base having a plurality of mounting holes and a length, width, and height, the rectangular base having around aspect ratio of 3:2 of the length to the width, the height being around five percent of the width;
a plurality of heat exchange members in thermal communication with a surrounding working fluid;
wherein each of the plurality of heat exchange members have a first dimension and a second dimension, the first dimension being at least a distance between the positive lead and the negative lead, the second dimension being orthogonal to the first dimension and at least a distance at least a distance from a bottom of a heat exchange member the plurality of heat exchange members in contact with the positive and negative leads to a top of the heat exchange member;
wherein the thermal communication with the working fluid occurs over the length of the first dimension;
wherein a ratio of the first dimension to the second dimension is around at least 2:5.

18. The bus bar of claim 17, wherein the plurality of heat exchange members are fins.

19. The bus bar of claim 17, wherein the plurality of heat exchange members are predominantly trapezoidal.

20. The bus bar of claim 17, wherein the thermal mass includes a plurality of vent holes.
